(19) United States
(12) Patent Application Publication
(10) Pub. No.: US 2025/0353243 A1
(43) Pub. Date: Nov. 20, 2025

(54) GRIPPER UNIT AND STRETCHING UNIT

(71) Applicant: BRÜCKNER MASCHINENBAU GmbH, Siegsdorf (DE)

(72) Inventors: Kilian LACHNER, Traunreut (DE); Martin SWOBODA, Freilassing (DE); Thomas ROTT, Siegsdorf (DE); Marvin BÖSL, Übersee (DE); Matthias MITTERER, Übersee (DE)

(21) Appl. No.: 19/210,627

(22) Filed: May 16, 2025

(30) Foreign Application Priority Data
May 16, 2024 (DE) 10 2024 113 826.2

(51) Int. Cl. B29C 55/20; B29C 55/08; B29C 55/16; B29L 7/00

(52) U.S. Cl. CPC B29C 55/20; B29C 55/08; B29C 55/165; B29L 2007/008

(57) ABSTRACT

The present disclosure relates to a gripper unit for a stretching unit as well as a stretching unit. The gripper unit includes a base body, a gripping jaw and at least one blade flap. The blade flap is located pivotably on the base body about a pivot axis and includes a complementary gripping jaw on one first end, the complementary gripping jaw interacting with the gripping jaw in a gripping position in order to grip a material web. In addition, the blade flap includes a neck section and a head section, wherein the neck section extends from the pivot axis to the head section, the head section forming a second end of the blade flap. The head section has an upper length (L_{K}) measured in a direction of travel (R) of the gripper unit, which is at least 50% longer than a minimum length (L_{H}) of the neck section.

### CROSS REFERENCE TO RELATED APPLICATION

This application claims priority to German Patent Application Number DE 10 2024 113 826.2, filed May 16, 2024, the entire contents of which is hereby incorporated by reference.

### BACKGROUND

The present disclosure relates to a magnetically opening gripper unit for a stretching unit, and a stretching unit comprising a magnetic opening device and at least one corresponding gripper unit.

Stretching units are used particularly in the production of plastics films. Normally, the material web to be stretched, in general a plastic film, is gripped in such units by means of gripper units and moved through the stretching unit. The gripper units are guided typically on revolving guide rails and located moveably.

A further component of a stretching unit is what is termed the transport system, which comprises, among other things, the guide rails and a drive system. In any case, the guide rails are located completely or partially in an oven. This enables the material web (particularly a plastic film) to be temperature controlled before and/or during the stretching (particularly to be heated up, or to be maintained at a desired temperature).

The revolving guide rails guide the gripper units on a path of motion. The drive unit of the gripper units can occur centrally, or the gripper units can be driven separately.

For a central drive unit, the gripper units can comprise chain links and/or be connected to each other into a chain strand via chain links.

The drive system can then drive the corresponding chain strand centrally.

To grip or to take hold of the material web, the grippers must be moved from an open position into a closed position (gripping position). This occurs in a what is termed the entry zone of the stretching unit.

Typically, a gripper unit comprises at least two clamping faces that are substantially opposite to each other and are used to grip the material web. By actuating a lever (also termed blade flap), the clamping faces can be moved towards each other until in the gripping position.

In addition, the blade flap is used to open the gripper unit in order to release the material web after being stretched. In particular, the gripper units must be opened again after the stretching process. The opening usually takes places after the stretched film has been guided by means of the gripper units through a further heating zone or cooling zone of the stretching unit.

After the gripper units are returned on a revolving guide rail, they can grip the material web once again and then move through the stretching region of the stretching unit once again. It is understood that the gripper units must be opened again before gripping anew.

To avoid wear and tear of the gripper units, the opening and closing of the gripper units occurs typically in a contactless manner. For example, what are termed magnetic opener and closing devices are known. In addition, what are termed mechanical forced opening or closing devices can be provided to ensure an opening or closing. These provide a stop which strikes gripper units which are not completely opened or closed when these gripper units are guided past the forced opening/forced closing devices.

This striking of the stop and rapid opening or closing, however, results in very high mechanical stresses so that the service life of the gripper units is reduced considerably. If a part of the gripper unit, such as the blade flap or another part of the gripping mechanism, breaks due to the impact stress, it can also result in other parts of the stretching unit being damaged and/or result in outage times and thus production losses.

The current trend in stretching units is to increase the production speed. However, the opening rate of known magnetic—and thus non-impact—opening devices decreases with increasing production speeds and the associated higher travel speed of the gripper units (this applies to closing devices accordingly).

Particularly in the case of very high-speed stretching units with a production speed, for example, of >500 m/min (with a corresponding high travel speed of the gripper units), as are used for the production of PET, PE, PP, PA films and suchlike, known gripper units are not opened/closed in a contactless manner with sufficiently high reliability so that it can result in undesired forced openings (correspondingly forced closings).

### SUMMARY

To ensure reliable contactless opening (and closing) of the gripper units-even at high travel speeds a gripper unit and a stretching unit according to the independent claims is provided. Further aspects of the disclosure are specified in the dependent claims and in the following description.

In particular, a gripper unit for a stretching unit is provided. The gripper unit can be designed for a transverse direction orienter or a simultaneous stretching unit.

A transverse direction orienter is a stretching unit in which a conveyed material web is stretched in particular in the transverse direction, i.e. in a direction that is substantially orthogonal to a conveying direction of the material web. In transverse direction orienters, the guide rails are arranged in a transverse stretching region in such a way, for example, that their spacing increases in the conveying direction. If stretching in the machine direction is also desired, a machine direction orienter can be upstream or downstream of the transverse direction orienter.

A simultaneous stretching unit is a stretching unit in which the stretching in the machine direction and the transverse direction occurs at the same time. For example, this can be achieved by quickly accelerating the separate gripper units on the guide rails differently. As a result, there is a stretching of the material web in the machine direction. Transverse stretching can be achieved at the same time through the arrangement of the guide rails so that their spacing increases in the conveying direction.

The gripper unit is configured to be guided on a guide rail of the stretching unit. To this end, the gripper unit can comprise at least one guide element. Said at least one guide element can be arranged on a base body of the gripper unit and be configured to guide the gripper unit on the guide rail. In particular, said at least one guide element can comprise a slide element or a guide roller.

Furthermore, the base body of the gripper unit can be configured to be connected to a chain link. The chain link can be part of a driven chain. Similarly, the gripper unit can comprise at least one chain link, wherein the base body can be connected in a fixed manner to said at least one chain link. Thus, multiple gripper units can be connected to a chain strand and are driven by a central drive unit.

Alternatively, each gripper unit can be driven separately. To this end, the guide rail—at least in regions—can be designed as a linear motor, or at least one linear motor is assigned to the guide rail.

In addition to the base body, the gripper unit according to the present disclosure comprises a gripping jaw and at least one blade flap. The gripping jaw can be designed integrally with the base body or can be connected to the base body (directly or indirectly). The gripping jaw can be a stationary or a moveable gripping jaw.

The blade flap (also termed clamping lever) is located pivotably on the base body about a pivot axis. For example, the blade flap can comprise a through opening for receiving a pivot axis. Alternatively, a pivot axis (or pivot axis sections) can be moulded on the blade flap or mounted on it.

The blade flap is located on the base body in such a way that it can be pivoted from a gripping position into an open position. Accordingly, it can be pivoted—in the opposing pivot direction—from the open position into the gripping position.

The blade flap comprises a complementary gripping jaw on one first end. The complementary gripping jaw acts together with the gripping jaw in the gripping position in order to grip the material web. In particular, the material web, for example a plastic film, can be clamped between the gripping jaw and the complementary gripping jaw and can thus be gripped.

To increase the gripping force, the gripping jaw and/or the complementary gripping jaw can be shaped. For example, the gripping jaws can comprise ribs and/or teeth. Similarly, the gripping jaws can be designed substantially even.

The blade flap also comprises a neck section and a head section. The neck section extends from the pivot axis to the head section, wherein the head section forms a second end of the blade flap. In particular, the pivot axis can be located between the complementary gripping jaw and the head section. Furthermore, a limb can extend from the pivot axis to the complementary gripping jaw. The limb and the neck section can meet at the pivot axis and form an angle that is in the range from 100° to 170°, or in the range from 120° to 150°.

The head section also has an upper length L_{K} which is at least 50% longer than a minimum length L_{H} of the neck section. The upper length L_{K} and the minimum length L_{H} are measured in a direction of travel R of the gripper unit (on the guide rail). The upper length L_{K} is here a length of the head section on its end edge, which can be located substantially parallel to the pivot axis. The minimal length L_{H} is measured in a region in which the neck section comprises its smallest linear expansion. In one aspect, this is in a region, in which the neck section adjoins the head section.

In one further aspect, the upper length L_{K} is at least 60% longer than a minimal length L_{H} of the neck section, or at least 70% longer than a minimal length L_{H} of the neck section, or at least 80% longer than a minimal length L_{H} of the neck section. Optionally, the upper length L_{K} is at the most 120% longer than a minimal length L_{H} of the neck section, or at the most 110% longer than a minimal length L_{H} of the neck section, or at the most 100% longer than a minimal length L_{H} of the neck section.

As a result of the longer shape of the head section, the magnetic force available for opening/closing the gripper unit can be increased considerably. It shows that the magnetic force can be increased by this design by up to 25% or even by up to 35%. This results in reliable opening of the blade flaps even at high travel speeds of >500 m/min, or >600 m/min or >700 m/min. In addition, the time interval is extended, in which a magnet of an opening device acts on the blade flap when the blade flap is guided past the magnet. In addition, this results in high reliability when opening. This applies accordingly to closing devices, i.e. for pivoting the blade flap from the open position into the gripping position.

Furthermore, the magnetic force can be increased through the shape of what is termed the blade angle φ. The blade angle φ is the angle that encloses a side edge of head section with a line that is parallel to the pivot axis. For example, the blade angle φ is in a range from 0° to 80°, or in a range from 30° to 75°, or in a range from 45° to 65°. It shows that the attainable increase in the magnetic force is the greatest in a region from 45° to 65°. From 65°, the increase is only marginal. Rapid travel speeds can be realised through the increase in the magnetic force.

In one aspect, the gripper unit can comprise multiple blade flaps (for example, two or three). In this aspect, the blade flaps are located preferably adjacent to each other in the direction of travel R of the gripper unit. Thus, a material web can be gripped with a gripper unit at multiple points. Thus, a holding force acting in the transverse direction of the material web is increased.

Furthermore, the length L_{H} of the neck section of the blade flap can taper in the direction of the head section at least, for example, in regions. This enables a reduction in the weight of the blade flap and determination of the position of the centre of gravity. In principle, it is desirable to design the movable blade flap as light as possible in order to attain the lowest possible inertia. This simplifies the opening and closing. Furthermore, the centre of gravity of the blade flap can be in the pivot axis or be located at least as near as possible to the pivot axis. As a result, the opening or closing is also simplified as less force must be applied for the opening and closing.

In a further aspect, the head section can comprise a recess or a through hole. As a result, weight can be saved and/or the position of the centre of gravity can be influenced. If the head section comprises a recess, this can comprise, for example, a depth amounting to at least 30%, or at least 50%, or at least 70% of the width of the head section. The width of the head section is measured in a direction that is orthogonal to the linear expansion of the head section (length L_{K}) and orthogonal to the main extension direction of the neck section.

This through hole or recess of the head section can comprise furthermore an upper edge that extends substantially parallel to an upper edge of the head section. The spacing between the upper edge of the recess or the through hole and the upper edge of the head section can be, for example, in the range from 2 mm to 6 mm, or in the range from 2.5 mm to 5 mm, or in the range from 3 mm to 4 mm. It has been shown that the ratio of increase in inertia to increase in magnetic force is ideal for these ranges.

In one aspect, the upper length L_{K} of the head section can be in the range from 20 mm to 60 mm, or in the range from 35 mm to 55 mm, or in the range from 45 mm to 50 mm.

In a further aspect, the head section comprises a larger width B_{K} than the neck section. This enables a further increase in the magnetic force. In particular, the width B_{K} can be in the range from 2 mm to 6 mm, or in the range from 3 mm to 5.5 mm, or in the range from 4 mm to 5 mm. It has been shown that greater widths do not result in a significant increase in the magnetic force.

In a further aspect, the head section of the blade flap has a height H_{K} that is in the range from 10 mm to 30 mm, or in the range from 15 mm to 25 mm, or in the range from 17 mm to 21 mm. The height H_{K} is measured in a direction that is in the main extension direction of the neck section (pointing from the pivot axis to the head section).

In a further aspect, the blade flap comprises a stop point for a prestressed element. For example, the prestressed element can be a compression spring. The prestressed element which can be part of the gripper unit according to this aspect is located between the stop point and the base body. This makes it possible to prestress the blade flap in the gripping position and thus increase the gripping force further and prevent unintentional opening of the blade flap.

In particular, the stop point can be located in a region between the complementary gripping jaw and the pivot axis, or the pivot axis can be located in a region between the complementary gripping jaw and the stop point. It has been shown that this arrangement results in high gripping force and good reliability when opening the blade flap.

In a further aspect, the head section can be magnetised more strongly than the neck section. This can be achieved by means of a corresponding heat treatment, in particular hardening, so that at least a martensitic structure occurs in the head section (in regions). In addition or alternatively, the head section comprises a lower carbon content so that stronger magnetisation is possible. As a result of the magnetisation of the head section, the magnetic force available for opening/closing the gripper unit can be increased further. Thus, even more rapid travel speeds can be realised without expecting losses in the reliability of the opening/closing.

In further aspect, the head section can comprise at least one magnet. As a result, the magnetic force available for the opening/closing can also be increased further.

Further a stretching unit, in particular a transverse direction orienter or a simultaneous stretching unit is provided. The stretching unit comprises at least one guide rail and at least one of the gripper units previously described. The gripper unit is guided here on the guide rail. The stretching unit can be configured to drive the gripper units at a travel speed of at least 500 m/min, or at least 600 m/min or at least 700 m/min in a revolving manner on the guide rail.

Furthermore, the stretching unit comprises at least one magnet opening device which opens the gripper unit (or the blade flap) in a contactless manner after passing through a stretching zone of the stretching unit.

Furthermore, the stretching unit comprises at least one magnet closing device which close the gripper unit (or the blade flap) in a contactless manner after passing through a stretching zone. This results in the gripping of the material web.

In particular, the magnetic opening device comprises at least one magnet, said magnet is located in the region of said at least one guide rail in such a way that the blade flap of a gripper unit is pivoted into the opening position when the gripper unit is guided past the magnetic opening device.

The magnetic closing device can also comprise at least one magnet, said magnet is located in the region of said at least one guide rail in such a way that the blade flap of a gripper unit is pivoted into the gripping position when the gripper unit is guided past the magnetic closing device.

In a further aspect, said at least one magnet has the length L_{M}, measured in a direction of travel of the gripper unit which fulfils the following condition:

0.8L_{K}≤L_{M}≤1.2L_{K}.

This enables the application of a strong magnetic force and thus reliable opening and closing.

In a further aspect, the upper length L_{K} is at least 30% longer than the length L_{M} of the magnet, or at least 40% longer than the length L_{M} of the magnet, or at least 50% longer than the length L_{M} of the magnet.

Optionally, the upper length L_{K} is at least 50% shorter than the length Ly of the magnet, or at least 40% shorter than the length L_{M} of the magnet, or at least 30% shorter than the length L_{M} of the magnet.

Furthermore, the spacing between two adjacent magnets of an opening device (correspondingly a closing device) can be smaller or equal to a (L_{M}−L_{K})/2. For example, the spacing between two adjacent magnets can be ≤4 mm, or ≤3 mm, or ≤2.5 mm.

This makes it possible to apply a nearly constant magnetic force on the blade flap over the length of the opening device or the closing device, thereby making it possible to increase the reliability of the opening/closing further. In particular, it is possible to avoid as a result that an already partially opened blade flap (or partially closed blade flap) returns unintentionally to the gripping position (or the open position).

In a further aspect, an air gap between said at least one magnet and the head section of a blade flap is in the range from 1.5 mm to 5 mm, or in the range from 2 mm to 4 mm or in the range from 2.5 mm to 3.5 mm. As a result, strong magnetic forces can be attained.

In addition, the stretching unit comprises at least one counter magnet which is located in the region of the magnet opening device (or closing device) in such a way that it forces said at least one gripper unit in the direction of the guide rail. Thus, it is possible to prevents the magnetic force acting through the magnetic opening device (or closing device) on the gripper unit from lifting the gripper unit from the guide rail.

### BRIEF DESCRIPTION OF THE DRAWINGS

The present disclosure is explained exemplarily in more detail in the following by means of the enclosed figures.

FIG. 1 shows a schematic view of a first embodiment of a stretching unit according to an aspect of the present disclosure,

FIG. 2 shows a schematic view of a second embodiment of a stretching unit according to an aspect of the present disclosure,

FIG. 3 shows a schematic view of a gripper unit according to an aspect of the present disclosure;

FIG. 4 shows a schematic view of a blade flap according to the state of the art;

FIG. 5 shows a schematic view of a blade flap according to an aspect of the present disclosure;

FIG. 6 shows a schematic view of a further blade flap according to an aspect of the present disclosure;

FIG. 7A shows a schematic view of a blade flap comprising magnets for opening/closing;

FIG. 7B shows a graph showing the progression of the magnetic force; and

FIG. 8 shows a further graph showing the progression of the magnetic force.

### DETAILED DESCRIPTION

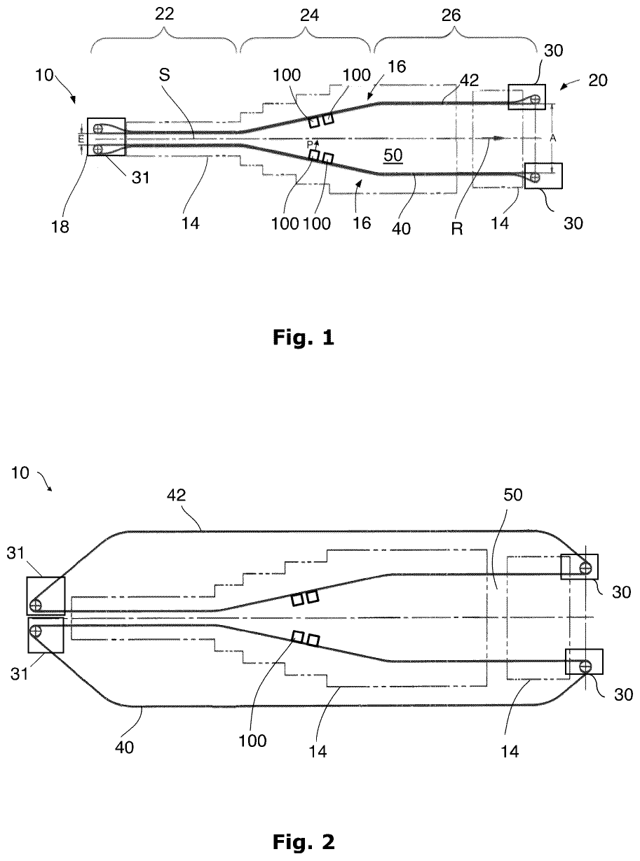

In particular, FIG. 1 shows a stretching unit 10. This comprises an oven 14 as well as two drive systems 16.

The drive systems 16 are located mirror-symmetrically with respect to a symmetry axis S of the stretching unit 10 and extend at least in part into the oven 14. The drive systems 16 run outside of the oven 14 in an entry zone 18 as well as an exit zone 20, in which a material web 50 of the stretching unit 10 is fed and removed.

In addition to the entry zone 18 and the exit zone 20, the stretching unit shown here comprises at least three further zones 22, 24, 26.

The zones 22, 24, 26 adjoin each other so that, as seen along the usual direction of travel and drawing direction R of the stretching unit 10, the first zone 22 initially adjoins the entry zone 18, then the second zone 24, then the third zone 26, and finally the exit zone 20.

The drive systems 16 have a first spacing from each other in the first zone 22 of the stretching unit 10 which adjoins the entry zone 18, said first zone 22 also being termed the preheating zone.

In the second zone 24, also termed the stretching zone, the spacing of both drive systems 16 from each other increases until finally at the start of the third zone 26, also termed heat treatment zone, a second spacing is attained.

Each of the drive systems 16 has a guide rail 40, 42 in the known manner, on which a multitude of gripper units 100 are guided. The gripper units 100 can be moved along the guide rail 40, 42 by means of a drive of the respective drive system 16.

In FIGS. 1 and 2, only two gripper units 100 per drive system 16 are shown symbolically in each case. The stretching unit 10 comprises however a plurality of gripper units 100.

The guide rails 40, 42 of the respective drive systems 16 circle a closed path from the entry zone 18 to the exit zone 20 and back again. The guide rail section forming the forward travel extends in the intended direction of travel of the gripper units 100 between the entry zone 18 and the exit zone 20 within the oven 14.

The guide rail section that runs from the exit zone 20 to the entry zone 18 in the normal operating direction and forms the return is also located within the oven 14 in the shown embodiment. As shown in the embodiment according to FIG. 2, it can however be located outside the oven 14.

To operate the stretching unit 10, the material web 50 to be stretched, for example a plastic film, is fed into the entry zone 18 of the stretching unit 10 in the drawing direction R. To this end, the material web 50 is fastened by means of its edges running in the drawing direction R to both drive systems 16.

More specifically, the edges of the material web 50 clamped by a corresponding gripper unit 100 and thus moved by the movement of the gripper units 100 along the guide rails 40, 42 of the drive systems 16.

In the entry zone 18, the material web 50 has a width E (entry width) perpendicular to the drawing direction R that corresponds approximately to the first spacing between the drive systems 16.

The material web 50 is then guided through the first zone 22 and heated there. In the subsequent second zone 24, thus the stretching zone, the material web 50 is stretched as the spacing of the drive systems 16 is increased continuously. At the end of the second zone 24, the material web 12 has a second width A (exit width).

After completing the stretching, the material web 50 now passes through the third zone 26, in which a relaxation of the material web 50 can take place before the material web 50 is detached from the gripper units 100 in the exit zone 20 and leaves the stretching unit 10 with the width A.

For example, the stretching unit 10 is a film-spreading stretching unit or transverse direction orienter, also referred to in short as a TDO. It is also conceivable that the stretching unit 10 is a simultaneous stretching unit, in which the material web 50 can be stretched in the second zone 24, thus the stretching zone, not only in the direction transverse to the drawing direction R but also in the drawing direction R.

During the processing of the material web 50, large tensile forces act in a tensile direction above all on the gripper units 28 in the second zone 24, thus the stretching zone. The tensile direction is predominantly in a primary direction P of the gripper units 100 and to a lesser extent transverse to the primary direction P.

Furthermore, the stretching unit 10 comprises at least one magnetic opening device 30 which opens the gripper units 100 after passing through the stretching unit or the relaxation zone in a contactless manner (magnetically). Furthermore, the stretching unit comprises at least one magnetic closing device 31 which closes the gripper units 100 in a contactless manner in order to grip the material web 50.

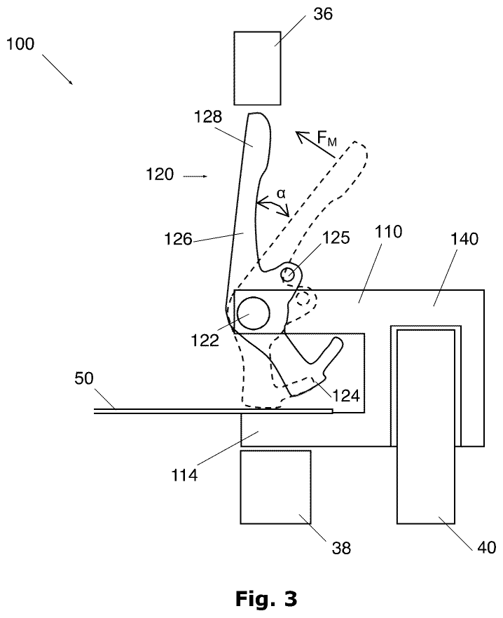

FIG. 3 shows a schematic view of a gripper unit 100 according to an aspect of the present disclosure.

The gripper unit 100 comprises a base body 110 and a blade flap 120. The blade flap 120 is mounted pivotably (angle α) on the base body 110 about a pivot axis 122 in order to be pivoted from a gripping position (dashed representation) into an open position (solid line).

Furthermore, the gripper unit 100 comprises a guide element 140 which is used to guide the gripper unit on a guide rail 40.

A gripping jaw 114 is located additionally on the base body 110 (or designed integrally with the base body 110) which interacts with a complementary gripping jaw 124 that is part of the blade flap 120. In the gripping position, the material web 50 is clamped between the gripping jaws 114, 124.

Furthermore, the blade flap 120 comprises a neck section 126 and a head section 128. The neck section 126 extends from the pivot axis 122 to the head section 128.

To be capable of opening or closing the blade flap, magnetic opening or closing devices 30, 31 can be used which comprise at least one magnet 36. Depending on the arrangement of the magnet 36, a magnetic force F_{M} acts on the blade flap 120, in particular its head section 128, said magnetic force F_{M} forcing the blade flap into the gripping position (as in FIG. 3) or into the open position.

To prevent that the magnet 36 lifts the gripper unit 100 from the guide rail 40, a counter magnet 38 can be arranged which draws the gripper unit 100 to the guide rail 40.

Furthermore, a stop point 125 can be located on the blade flap (for example in the form of an ear). The stop point 125 is used to fasten a prestressed element (not shown). The prestressed element, in particular a compression spring, can be located between the stop point 125 and the base body 110 in such a way to prestress the blade flap 120 in the gripping position.

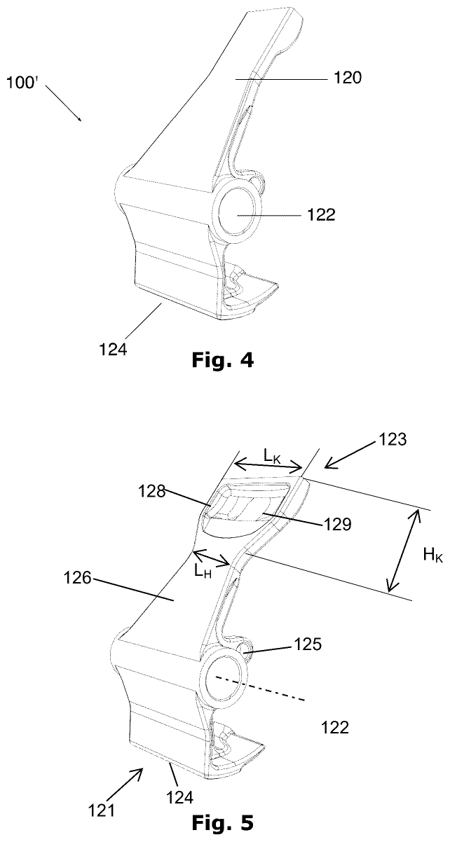

FIG. 4 shows a schematic view of a blade flap according to the state of the art. This known blade flap 120 can also be mounted about a pivot axis 122 in order to be pivoted from an open position into a gripping position. However, a neck and head section according to an aspect of the present disclosure is not provided here so that this type of blade flap cannot be opened reliably and accordingly also cannot be closed reliably by means of the magnetic opening device at high speeds.

In FIG. 5, a blade flap 120 of a gripper unit 100 according to an aspect of the present disclosure is shown. This blade flap 120 comprises a neck section 126 that extends from the pivot axis 122 to the head section 128. At one first end 121, the blade flap comprises a complementary gripping jaw 124. On the opposing second end 123, the head section 128 is located.

The head section 128 has an upper length L_{K} (measured in a direction of travel R of the gripper unit 100) which is at least 50% longer than a minimum length L_{H} of the neck section 126. The shown blade flap thus tapers in the neck section before it widens again in the head section.

In the example shown here, the upper length L_{K} of the head section 128 is in the range from 20 mm to 60 mm, in particular in the range from 35 mm to 55 mm, in particular in the range from 45 mm to 50 mm.

Furthermore, the head section can comprise a height H_{K}, measured in the main extension direction of the neck section that is in the range from 10 mm to 30 mm, or in the range from 15 mm to 25 mm, or in the range from 17 mm to 21 mm

This geometry results in a considerable increase in the magnetic force F_{M} so that more rapid line speeds are possible with consistently high reliability when opening/closing.

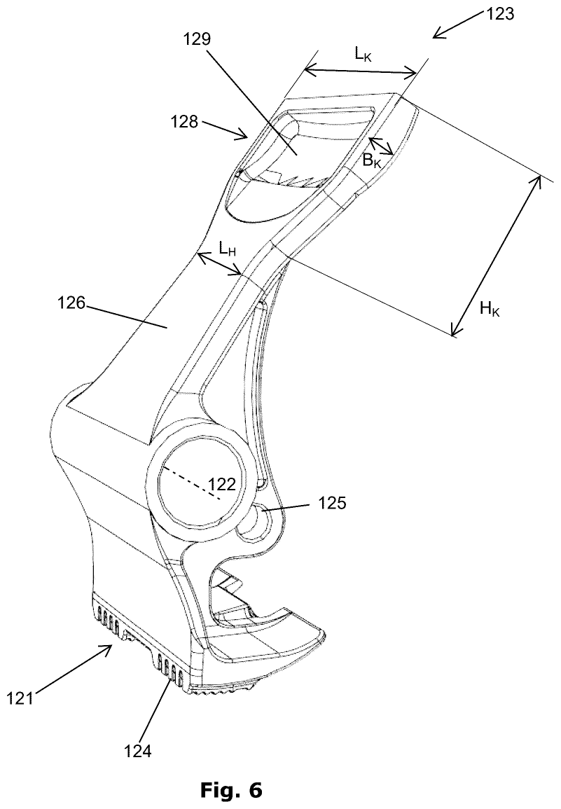

Optionally, the head section 128 comprises a recess 129 or a through hole. This is described in detail in relation to FIG. 6.

As shown in FIG. 5, the stop point 125 can be in a region between the pivot axis 122 and the head section 128. It is however also possible to locate the stop point 125, as shown in FIG. 6, between the complementary gripping jaw 124 and the pivot axis 122.

FIG. 6 shows a further blade flap 120 of a gripper unit 100 according to an aspect of the present disclosure. Same elements are denoted here with the same reference signs so that a repeated description has been dispensed with.

In the blade flap 120 shown in FIG. 6, the head section 128 comprises a larger width B_{K} than the neck section 126. The width B_{K} of the head section 128 is optionally in the range from 2 mm to 6 mm, or in the range from 3 mm to 5.5 mm, or in the range from 4 mm to 5 mm.

A recess 129 is also introduced into the head section 128. The recess 129 comprises a depth amounting to at least 30%, or at least 50%, or at least 70% of the width B_{K} of the head section 128.

Furthermore, the recess 129 comprises an upper edge that extends substantially parallel to an upper edge of the head section 128. The upper end of the head section is thus designed thicker. Similarly, thickened regions can be designed laterally of the recess.

The spacing between the upper edge of the recess 129 and the upper edge of the head section 128 is, for example, in the range from 2 mm to 6 mm, or in the range from 2.5 mm to 5 mm, or in the range from 3 mm to 4 mm. The laterally thickened regions can comprise a linear expansion (in the direction of travel R) that is in the range from 2 mm to 6 mm, or in the range from 2.5 mm to 5 mm, or in the range from 3 mm to 4 mm.

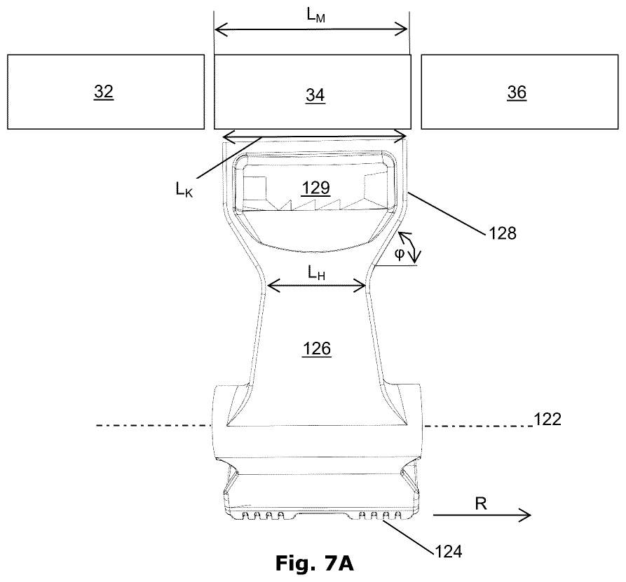

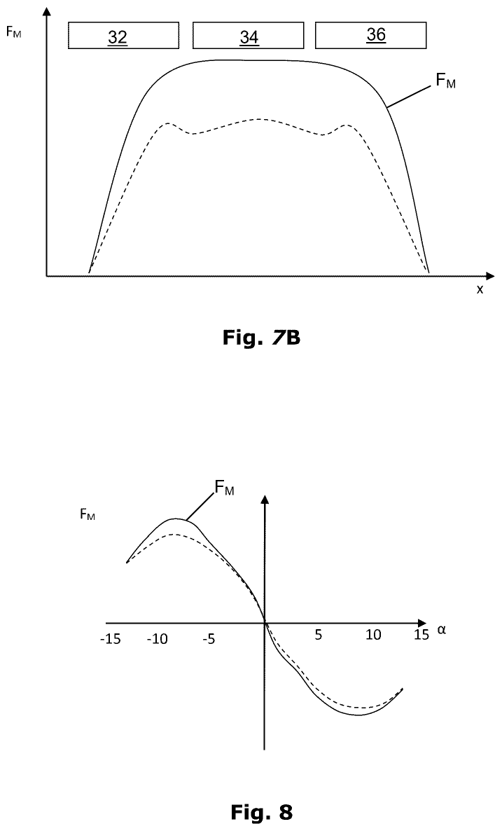

FIG. 7A shows the blade flap 120 from FIG. 5, which is guided past an opening device or its magnets 32, 34, 36 in the direction of travel R. Here, a magnetic force F_{M} acts on the head section 128 of the blade flap 120.

In addition, the blade angle φ is drawn here, thus the angle formed by a side edge of the head section with a line parallel to the pivot axis 122. For example, the blade angle φ is in a range from 0° to 80°, or in a range from 30° to 75°, or in a range from 45° to 65°.

The graph shown in FIG. 7B shows how the magnetic force F_{M} has changed in comparison to the blade flap of the state of the art shown in FIG. 4. The solid line shows the magnetic force F_{M} acting on the blade flap according to an aspect of the present disclosure. The dashed line shows the magnetic force F_{M} acting on a typical blade flap of the state of the art.

Firstly, the magnetic force could be increased by 25-35%. In addition, it shows that the progression of the magnetic force in the linear expansion x, i.e. in the direction of travel R, forms an even plateau-without local peaks. Both effects result in reliable opening/closing of the blade flap according to an aspect of the present disclosure.

In FIG. 8, a further graph is shown which shows the progression of the magnetic force F_{M} depending on the angular position a. The solid line shows the magnetic force F_{M} acting on the blade flap according to an aspect of the present disclosure. The dashed line shows the magnetic force F_{M} acting on a typical blade flap of the state of the art. Again, it shows here that in particular a considerably stronger magnetic force acts on the pivoted blade flap (deflection 10°)

The gripper units according to aspects of the present disclosure and the stretching unit can thus be operated at high speeds and provide at the same time high reliability during contactless opening/closing of the gripper units.

1. A gripper unit for a stretching unit, such as a transverse direction orienter or a simultaneous stretching unit, wherein
the gripper unit is configured to be guided on a guide rail, and wherein
the gripper unit comprises:
a base body, a gripping jaw and at least one blade flap, wherein
the blade flap is located pivotably on the base body about a pivot axis in order to be pivoted from a gripping position into an open position, wherein
the blade flap comprises a complementary gripping jaw on one first end, said complementary gripping jaw interacting with the gripping jaw in the gripping position to grip a material web, and wherein
the blade flap comprises a neck section and a head section, wherein
the neck section extends from the pivot axis to the head section, said head section forming a second end of the blade flap, and wherein
the head section has a upper length L_{K}, measured in a direction of travel of the gripper unit, said upper length L_{K} being at least 50% longer than a minimal length L_{H} of the neck section, measured in a direction of travel, R, of the gripper unit.

2. The gripper unit according to claim 1, wherein the gripper unit comprises multiple blade flaps, wherein
the blade flaps are arranged adjacent to each other in the direction of travel of the gripper unit.

3. The gripper unit according to claim 1, wherein the length of the neck section tapers in the direction of the head section at least in regions.

4. The gripper unit according to claim 1, wherein the head section comprises a recess or a through hole, wherein
the recess optionally comprises a depth amounting to at least 30%, or at least 50%, or at least 70% of the width of the head section.

5. The gripper unit according to claim 4, wherein the recess or the through hole comprises an upper edge that runs substantially parallel to an upper edge of the head section, wherein
the spacing between the upper edge of the recess or the through hole and the upper edge of the head section is optionally in the range from 2 mm to 6 mm, or in the range from 2.5 mm to 5 mm, or in the range from 3 mm to 4 mm.

6. The gripper unit according to claim 1, wherein
the upper length L_{K} of the head section is in the range from 20 mm to 60 mm, or in the range from 35 mm to 55 mm, or in the range from 45 mm to 50 mm, and/or wherein
the blade angle (φ) of the head section is in a range from 0° to 80°, or in a range from 30° to 75°, or in a range from 45° to 65°.

7. The gripper unit according to claim 1, wherein the head section comprises a larger width (B_{K}) than the neck section, and wherein
the width B_{K} of the head section is optionally in the range from 2 mm to 6 mm.

8. The gripper unit according to claim 1, wherein the head section comprises a height H_{K}, measured in the main extension direction of the neck section, in the range from 10 mm to 30 mm.

9. The gripper unit according to claim 1, wherein the gripper unit comprises furthermore at least one guide element, wherein
said at least one guide element is arranged on the base body and is configured to guide the gripper unit on a guide rail, and wherein
said at least one guide element comprises a slide element or a guide roller.

10. The gripper unit according to claim 1, wherein
the base body is configured furthermore to be connected to a chain link and/or wherein
the gripper unit comprises at least one chain link, wherein the base body is connected in a fixed manner to at least one chain link.

11. The gripper unit according to claim 1, wherein the blade flap comprises a stop point for a prestressed element, and wherein a prestressed element, such as a compression spring, is located between the stop point and the base body in order to prestress the blade flap in the gripping position.

12. The gripper unit according to claim 11, wherein
the stop point is located in a region between the complementary gripping jaw and the pivot axis, or wherein
the pivot axis is located in a region between the complementary gripping jaw and the stop point.

13. The gripper unit according to claim 1, wherein the head section is magnetized greater than the neck section and/or wherein the head section comprises at least one magnet.

14. The gripper unit according to claim 1, wherein the blade flap is made of steel, and wherein the head section comprises a lower carbon content than the neck section.

15. The gripper unit according to claim 1, wherein the head section is heat-treated.

16. The gripper unit according to claim 15, wherein the head section is hardened.

17. A stretching unit, wherein
the stretching unit comprises at least one guide rail and at least one gripper unit according to claim 1, wherein the gripper unit is guided on the guide rail.

18. The stretching unit according to claim 17, wherein the stretching unit is a transverse direction orienter or a simultaneous stretching unit.

19. The stretching unit according to claim 17, wherein
the stretching unit comprises at least one magnetic opening device and/or at least one magnetic closing device,
said magnetic closing device comprising at least one magnet, said magnet being located in the region of said at least one guide rail in such a way that the blade flap of a gripper unit is pivoted into the open position when the gripper unit is guided past the magnetic opening device, and
said magnetic closing device comprising at least one magnet, said magnet being located in the region of said at least one guide rail in such a way that the blade flap of a gripper unit is pivoted into the gripping position when the gripper unit is guided past the magnetic closing device.

20. The stretching unit according to claim 19, wherein said at least one magnet has a length (L_{M}), measured in a direction of travel (R) of the gripper unit (100), which fulfils the condition 0.8 L_{K}≤L_{M}≤1.2 L_{K}.

21. The stretching unit according to claim 19, wherein the spacing between two adjacent magnets is smaller or equal to (L_{M}−L_{K})/2.

22. The stretching unit according claim 17, wherein an air gap(s) between said at least one magnet and the head section of a blade flap is in the range from 1.5 mm to 5 mm.
